(19) United States
(12) Patent Application Publication
(10) Pub. No.: US 2018/0177345 A1
(43) Pub. Date: Jun. 28, 2018

(54) UTENSIL HOLDER

(71) Applicant: Umbra LLC, Buffalo, NY (US)

(72) Inventor: Brandon Kyle Williams, Evanston, IL (US)

(21) Appl. No.: 15/414,896

(22) Filed: Jan. 25, 2017

Related U.S. Application Data
(60) Provisional application No. 62/437,821, filed on Dec. 22, 2016.

(51) Int. Cl. A47J 47/16

(52) U.S. Cl. CPC A47J 47/16

(57) ABSTRACT

A device or utensil holder is presented in which an outer shell with an open bottom houses a plurality of elastomeric grip pairs. The grip pairs include two grip members that contact each other. The grip pairs are pressed into contact with each other by one or preferably two end caps that along with the walls of outer shell hold the grip pairs in a pressed together state. When a utensil or other device is moved between grip members, the elastomeric grip members react to hold the utensil thereby enabling to hang from the holder.

### CROSS REFERENCE TO RELATED APPLICATIONS

This application claims the benefit priority under 35 U.S.C. § 119 (e) from U.S. Provisional Application No. 62/437,821 filed Dec. 22, 2016 which application is incorporated herein by reference in its entirety.

### FIELD OF THE INVENTION

The present invention relates generally to the field of containers, more specifically to holders that are able to hold devices in a separate manner, and still more specifically to holders that are mountable on walls or similar surfaces,

### BACKGROUND OF THE INVENTION

Although all users of kitchens and other workspaces desire such work areas to have ample floor space and counter space, affordable houses and apartments often have smaller kitchens and work areas in which counter space is at a premium. In situations with small work areas and counters, space is often occupied by containers that hold tools, utensils, small appliances, and other devices which reduce the amount of open work space available to actually perform work activities such as chopping vegetables, peeling fruit, and rolling dough. Also limited is space to temporarily keep prepared ingredients while subsequent preparations proceed.

Often containers are used to hold a number of utensils, tools, or other devices. For example, decorative containers are available to hold such kitchen devices as spatulas, ladles, whisks, spoon, etc. Work benches often hold screwdrivers, small hammers, awls, pliers, etc. However, no matter how attractive a utensil/tool/device container may be, it is using valuable open space that can be used for work activities or placement of small appliances, workpieces, prepared ingredients or cooked food, as well as other items.

In addition, multiple utensils or other devices stored in containers often become tangled with each other or smaller utensils may be hidden by larger devices. This makes it more difficult to select and use the desired implement in an efficient.

Therefore, what is needed is a storage unit for utensils and other devices that removes the utensils from the workspace on a counter or work table, allows for the separate storage of those utensils, and easy recognition of the exact implement desired.

### SUMMARY OF THE INVENTION

The present invention broadly comprises a utensil or device holder including: an outer shell having a top wall, a front wall, a back wall, two opposing open ends, and an open bottom, wherein the outer shell defines a shell space; at least one end cap configured to fit into one of the two opposing open ends; and, a plurality of grip pairs, each of the grip pairs including two grip members, wherein each of the plurality of grip pairs contacts each adjacent grip pair. All of the plurality of grip pairs is housed within the shell. Preferably the at least one end cap is a pair of end caps.

In a preferred embodiment, the grip members are manufactured from an elastomeric substance and are c-shaped. The curve or bottom of each c-shaped grip member includes a plurality of contact ridges that contact the ridges of the other grip member of the grip pair.

In an alternate embodiment, the ends of the c-shaped grip member are formed into tips shaped to fit into longitudinal brackets attached to the inner surface of the side walls of the outer shell.

In a more preferred embodiment, the c-shape of the two grip members enables the grip pair to form a notch which can act as a guide in placing a device into the device holder.

One object of the invention is to provide a utensil or device holder that stores all the devices separately from each other. In this context, separately means that the utensils are not tangled with each other. Preferably, the stored utensils are not touching each other when held in the present invention.

A second object of the invention is to store devices, such as kitchen utensils in a visible manner so as to allow the user to easily select the desired utensil.

A third object of the invention is to provide for efficient use of space by mounting the holder on a wall thereby alleviating the need for a storage container on a counter or table and/or the filling of a drawer with various utensils.

### BRIEF DESCRIPTION OF THE SEVERAL VIEWS OF THE DRAWINGS

The nature and mode of the operation of the present invention will now be more fully described in the following detailed description of the invention taken with the accompanying drawing Figures, in which:

FIG. 1 is a bottom perspective view of the utensil/device holder of the present invention holding various kitchen utensils;

FIG. 2 is a top perspective view of the outer shell;

FIG. 3 is a back view showing the back wall of the shell;

FIG. 4 is a bottom view of the utensil holder with utensils removed depicting the plurality of grip pairs extending from the first end to the second end;

FIG. 5 is an exploded top perspective view of the utensil holder with the plurality of grip pairs removed from the outer shell;

FIG. 6 is a top perspective view of outer shell showing opposing pairs of brackets extending the length of the front wall and side wall of the shell;

FIG. 6A is an enlarged front view of one embodiment of a bracket pair;

FIG. 6B is an enlarged front view of an alternate embodiment of a bracket pair;

FIG. 7 is an enlarged top perspective view of a grip member depicting the preferred c-shape of the grip member;

FIG. 8 is a cross section along line 8-8 in FIG. 2 showing a grip pair housed completely within the space defined by the outer shell;

FIG. 9 is a top perspective view of the end cap; and,

FIG. 9A also shows more clearly the offset position of the end cap bosses in relation to the side edges of the end cap.

### DETAILED DESCRIPTION OF EMBODIMENTS OF THE INVENTION

At the outset, it should be appreciated that like drawing numbers on different drawing views identify identical structural elements of the invention. It also should be appreciated that figure proportions and angles are not always to scale in order to clearly portray the attributes of the present invention.

While the present invention is described with respect to what is presently considered to be the preferred embodiments, it is understood that the invention is not limited to the disclosed embodiments. The present invention is intended to cover various modifications and equivalent arrangements included within the spirit and scope of the appended claims.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. It should be appreciated that the term “substantially” is synonymous with terms such as “nearly”, “very nearly”, “about”, “approximately”, “around”, “bordering on”, “close to”, “essentially”, “in the neighborhood of”, “in the vicinity of”, etc., and such terms may be used interchangeably as appearing in the specification and claims. It should be appreciated that the term “proximate” is synonymous with terms such as “nearby”, “close”, “adjacent”, “neighboring”, “immediate”, “adjoining”, etc., and such terms may be used interchangeably as appearing in the specification and claims. Although any methods, devices or materials similar or equivalent to those described herein can be used in the practice or testing of the invention, the preferred methods, devices, and materials are now described.

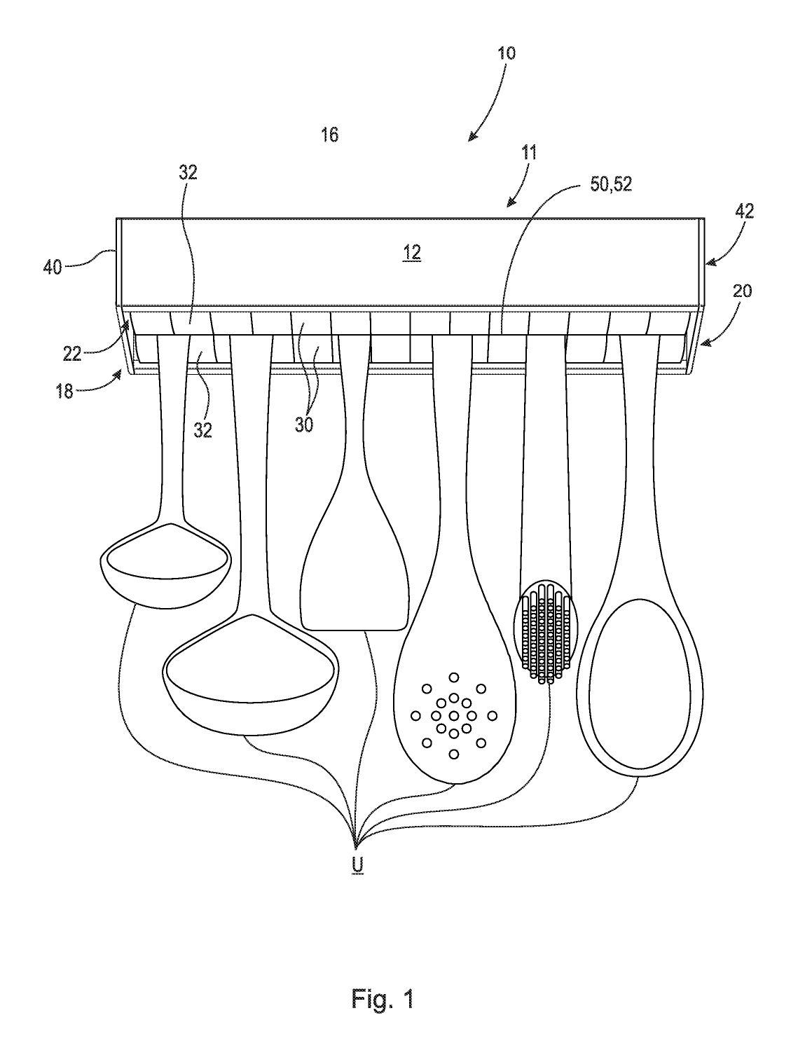

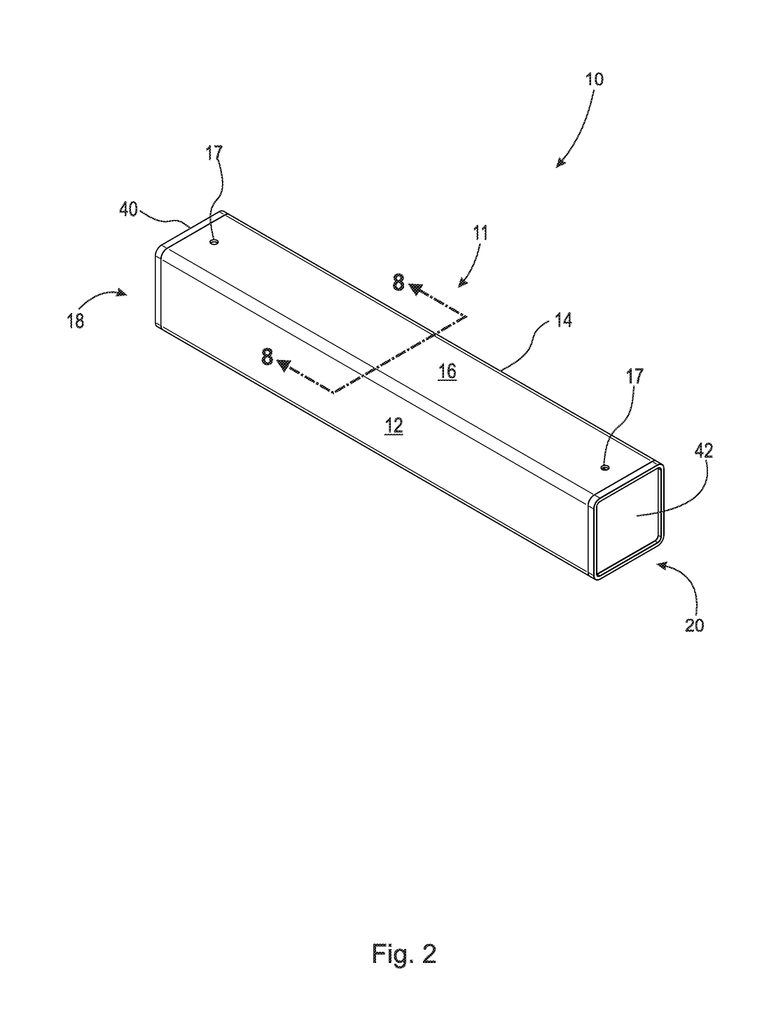

Averting to the drawing figures, FIG. 1 is a bottom perspective view of utensil/device holder 10 (“holder 10”) holding various utensils U. Holder 10 includes outer shell 11 and a plurality of grip pairs 30. Each grip pair 30 includes two grip members 32 which contact each other as described below. The grip pairs 30 are housed at least partially in shell space 22 which is defined by front wall 12, back wall 14 (not seen in FIG. 1), and top wall 16 (not seen in FIG. 1. It can be seen that shell 11 has an open bottom. Although one end of shell 11 may be open while the opposite end is closed with an end cap, it is preferred that both open ends 18 and 20 are capped by end caps 40 and 42, respectively, as described below. Outer shell 11 defines a shell space 22 (“space 22”) enclosed by front wall 12, back wall 14, and top wall 16 as well as end caps 40 and 42. FIG. 2 is a top perspective view of holder 10. Fastening holes 17 are seen defined by top wall 16 of outer shell 11. End caps 40 and 42 cover ends 18 and 20.

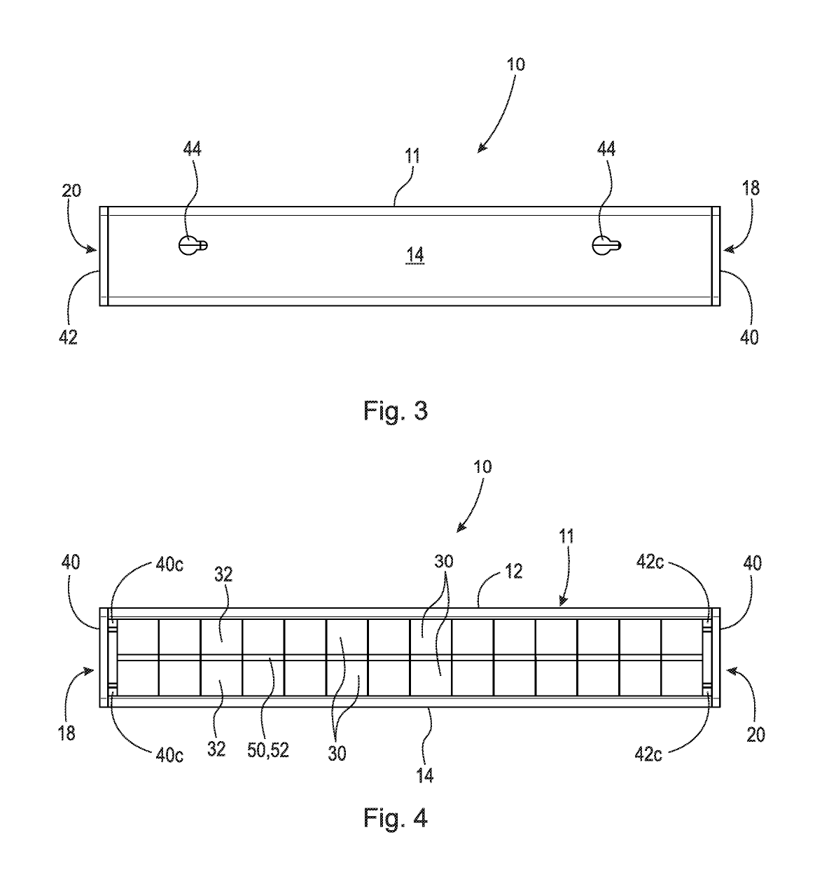

FIG. 3 is a back view of shell 11 showing back wall 14. Mounting holes 44 are defined by back wall 14. In the figure, mounting holes 44 are keyhole shaped and have a horizontal or longitudinal (length-wise) orientation in relation to shell 11. With the keyhole shape and horizontal orientation, holder 10 may be installed on a wall by pushing the wider portion of each of the keyhole shapes over a screw head and then moving the entire holder 10 assembly toward the narrower portion of the keyhole shape. Persons of skill in the art will recognize that other shapes and orientations of mounting holes 44 are possible.

FIG. 4 is a bottom view of holder 11 with utensils U removed. The plurality of grip pairs 30 extends from end 18 to end 20. Each grip pair 30 is held by end caps 40 and 42 so as to contact each adjacent grip pair 30. As explained below, preferably each grip pair 30 forms a notch 50. Groove 52 is formed by the contact of adjacent grip pairs 30 which are all aligned so that notches 50 (not shown in FIG. 4) of each grip pair 30 together from groove 52.

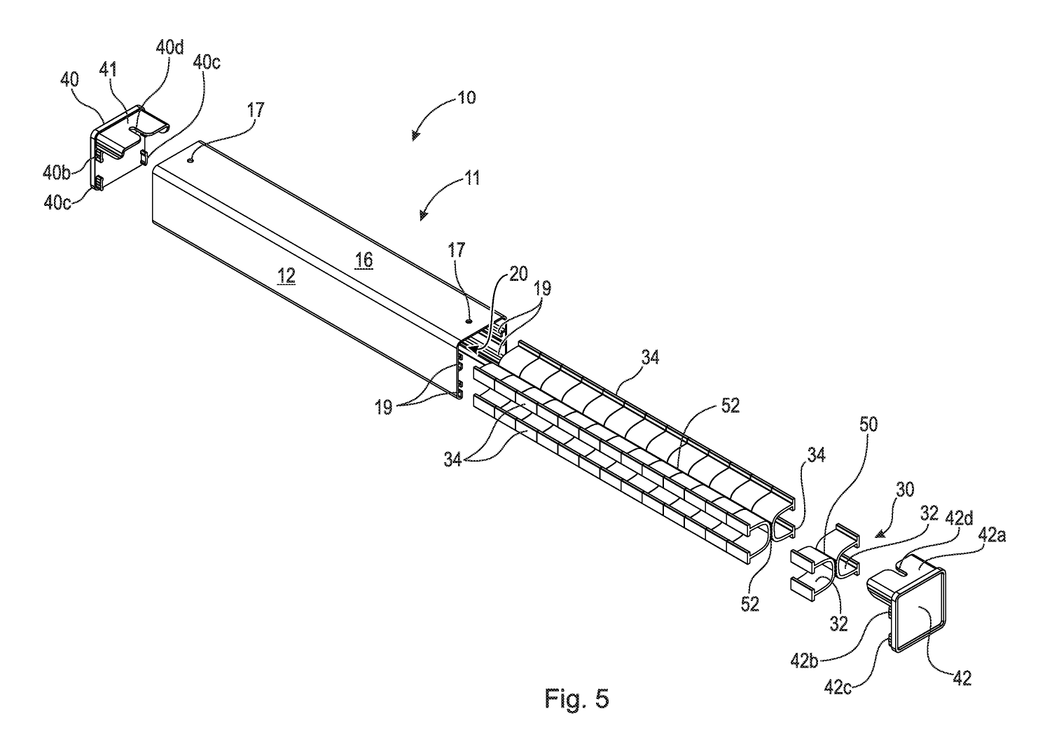

FIG. 5 is an exploded top perspective view of utensil holder 10 with the plurality of grip pairs 30 removed from outer shell 11. Two c-shaped grip members 32 are attached together at the respective curved portions to form opposing notches 50. It can be seen in FIG. 5 that when the plurality of grip pairs 30 is placed within shell 11 each grip pair contacts adjacent grip pair(s) 30. The opposing notches 50 on each grip pair 30 together form opposing grooves 52. Bottom groove 52 is seen in the schematic bottom view of FIG. 3. Opposing in this context means on opposite sides from each other.

FIG. 5 also shows pairs of opposing brackets 19 extending the length of each of front wall 12 and back wall 14. As will be explained below, the upper and lower tips 34 of each grip member fit into brackets 19 to hold each grip pair in place against front wall 12 and back wall 14. As seen in FIGS. 1 and 3, when all of grip pairs 30 are placed within space 22 of shell 11, the whole plurality of grip pairs 30 extends from end 18 to end 20 of shell 11 and is held in place by end caps 40 and 42. Brackets 19 may be attached to front wall 12 and back wall 14 or may be integral with the inner surfaces of front wall 12 and back wall 14. Integral in this context means that the component parts are formed together as a single unit.

End caps 40 and 42 each include a header 40a and 42a, respectively, offset from the edges 41 and 43 (not seen in FIG. 5) for the respective end cap such that headers 40a and 42a fit under top wall 16 to form a friction fit. Offset in this context means moved slightly away from. Pairs of upper bosses 40b and lower bosses 40c are also offset from inner edge 41 and also extend into shell 11 to create a friction fit against front wall 12 and rear wall 14 to help hold end cap 40 in place inside shell 11. Similar pairs of upper bosses 42b and 42c perform the same function for end cap 42. Each header 40a and 42a is configured to include slots 40d and 42d, respectively that act as an attachment orifice to receive an attachment device through attachment holes 17. An attachment device such as a screw or rivet may be used to hold end caps 40 and 42 against ends 18 and 20. Persons of skill in the art will recognized that attachment orifices may have shapes other than slots such as circular holes or key shaped holes. In addition, it will be recognized that other attachment devices known in the art may be used to hold end caps 40 and 42 in place against ends 18 and 20 of shell 11.

When the end caps 40 and 42 are attached to shell 11 as described above, they act to hold the grip pairs 30 in contact against adjacent grip pairs. The elastomeric material of the grip pairs 30 is squeezed so that the each grip pair 30 is kept in contact with adjacent grip pairs 30 or with end caps 40 and 42.

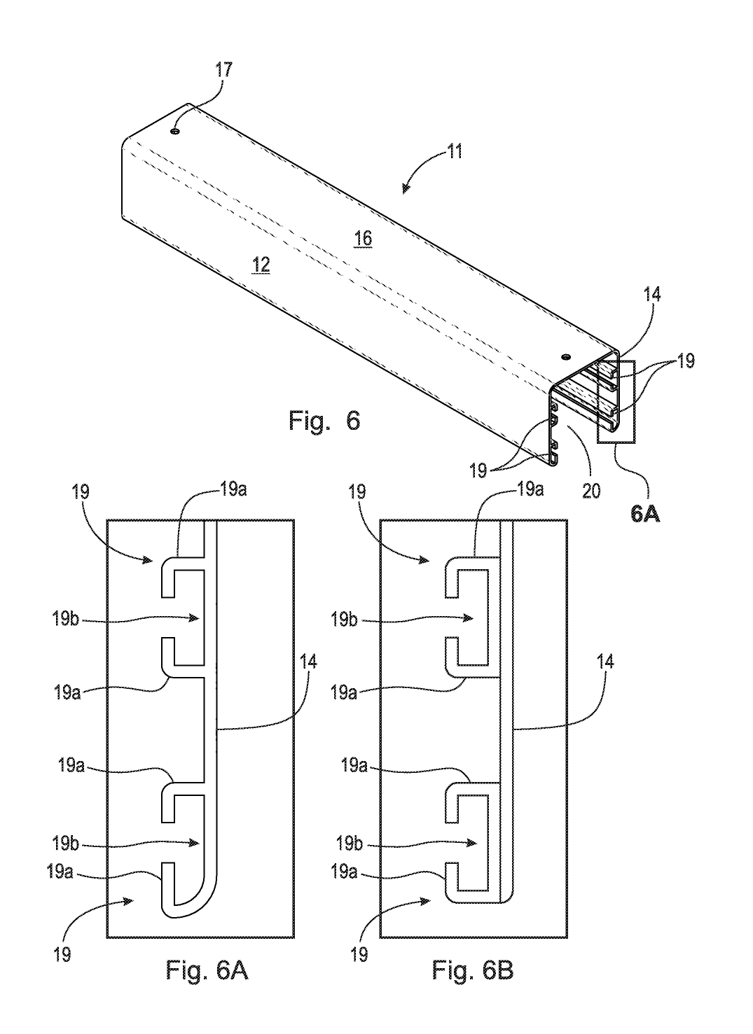

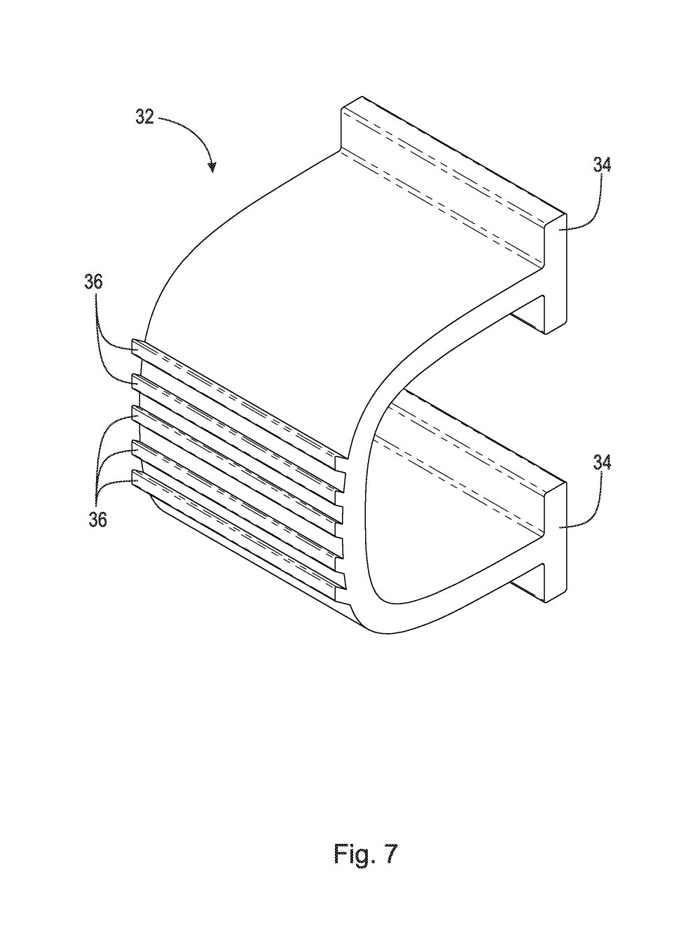

FIG. 6 is a top perspective view of outer shell 11 showing bracket pairs 19. FIG. 6A is an enlarged front view depicting one embodiment of one bracket pair 19 in which brackets 19 are integral with shell 11. Integral in this context means that the component parts are formed together as a single unit. FIG. 6B depicts an alternate embodiment in which brackets 19 are attached to shell 11. Attachment may be performed by such method as welding, brazing, adhesives, and other methods known in the art. In both embodiments, in can be seen that each member of the bracket pairs 19 is shaped to receive the end tips 34 of each grip member 32. In the configuration shown, each bracket 19 includes opposing L-shaped arm 19a that defined spaces 19b. As will be shown below, arms 19a are shaped to receive tips 34 of grip members 32 such that each grip pair 30 may be pushed from one end of shell 11 to the other end with the tips 34 of each grip member 30 held within space 19b.

FIG. 7 is an enlarged top perspective view of grip member 32 in a preferred c-shape configuration. Tips 34 are shown at the ends of the two legs of the c shape. At the curve of the c is a plurality of contact ridges 36 (“ridges 36”). Preferably, grip member 32 is manufactured from an elastomeric material, such as thermoplastic rubber (TBR) that will tend to move strongly to its original shape when squeezed, pressed, or otherwise mechanically distorted.

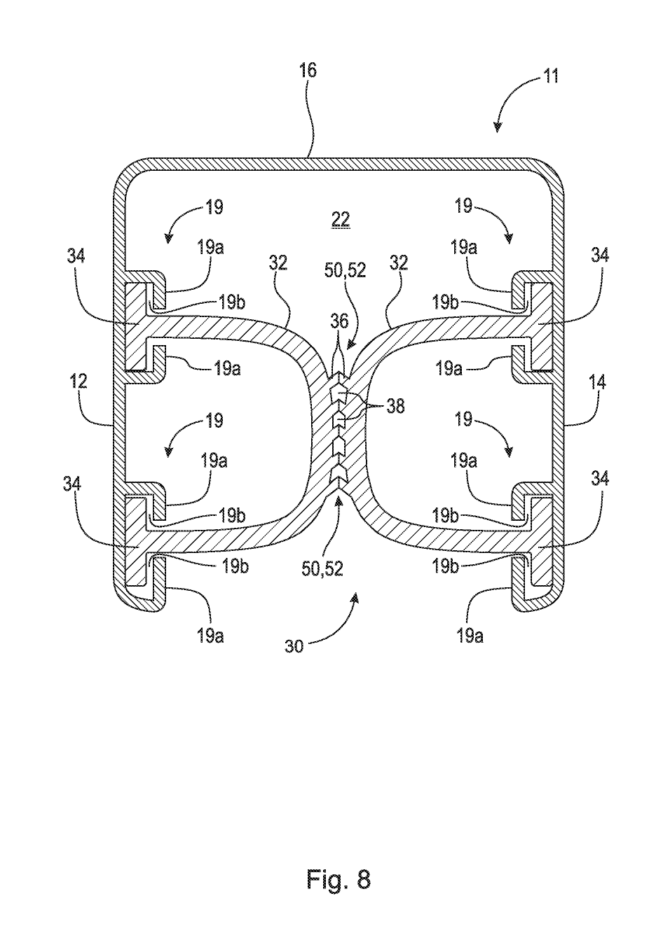

FIG. 8 is a cross section along line 8-8 in FIG. 2 showing grip pair 30 housed completely within space 22 of outer shell 11. As can be seen, grip pair 30 is formed by two grip members 32 contacting each other in a “back-to-back” formation through contact ridges 36. A contact orifice 38 is formed by adjacent paired ridges 36. FIG. 8 depicts a preferred embodiment in which contact ridges 36 extend toward top wall 16. Other embodiments are also possible in which ridges 36 extend away from top wall 16 toward the open bottom or in a direction perpendicular to front wall 12 and back wall 14. Upper and lower notches 50 are formed by the back-to-back formation of the grip pair 30. As discussed above, the notches 50 of adjacent grip pairs 30, in contact with each other, will form upper and lower grooves 52. It will be recognized that grip members and grip pairs having other conformations may be used in a similar manner, although it is preferred that any alternate conformations result in grooves similar to grooves 52. It will also be recognized that the plurality of grip pairs 30 may be house partially within space 22 such that the plurality of grip pairs 30 extend partially below outer shell 11 so as be visible.

Also seen is the fitting of upper and lower tips 34 fit into upper and lower brackets 19. Sufficient space is available in spaces 19b to allow grip pairs 30 to be pushed longitudinally along to the end of shell 11 while still holding each grip pair 30 in place against front wall 12 and rear wall 14.

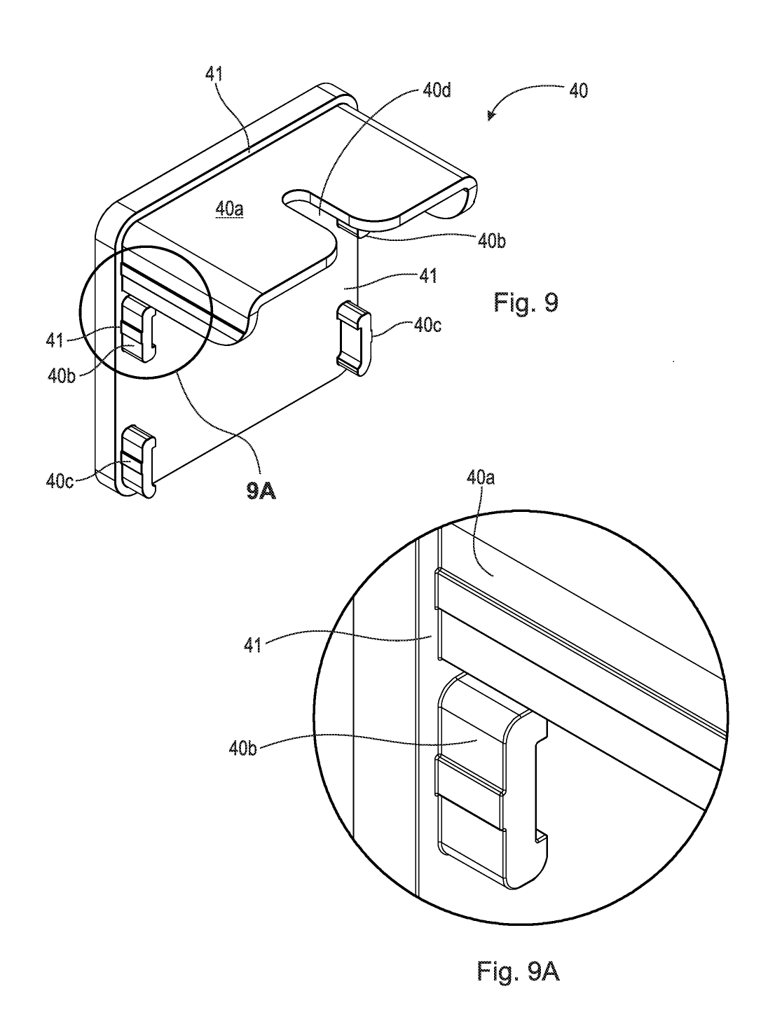

FIG. 9 is a top perspective view of end cap 40. Clearly seen is the offset position of header 40a and bosses 40b and 40c from inner edge 41. FIG. 9A also shows more clearly the offset position of bosses 40b and 40c. This offset formation of header 40a and bosses 40b and 40c allows end cap 40 to fit into and be held in space 22 of outer shell 11 by the friction fit of the bosses 40b and 40c, as well as header 40a against the inner surfaces of outer shell 11. In addition, as described above, an attachment device is preferably inserted through attachment hole 17 (not seen in FIGS. 9 and 9A) into attachment orifice 40d. FIG. 9 portrays a preferred embodiment of attachment orifice 40d in the form of a slot that allows for extending an attachment device such as a screw or rivet without the necessity of an exact alignment of an attachment orifice with attachment hole 17. It will be recognized that preferably opposing end cap 42 will have a similar configuration to incorporate the advantages discussed concerning end cap 40.

Utensil holder 10 may be mounted on a wall or other surface from which various kitchen utensils may be hung. Because one grip member 32 of a grip pair 30 contacts but is not attached to the other grip member 30 through ridges 36 allows a user to push the handle of a typical utensil such as a spoon or spatula, between grip members 32 of one or more grip pairs 32. The presence of contact orifices 38 between ridges 36 provides the advantage of making it easier to push the handle farther between grip members 32. The elastomeric nature of the TBR or other elastomeric material allows for separation of the of grip members 32 as the utensil is inserted between them and for the closing of grip members 32 around the utensil gripping the utensil thereby holding it in place until it is pulled out by a user. The presence of groove 52 provides the advantage of enabling the user to locate the contact point between ridges 36 of a grip pair 32 by feel without having to struggle to find the contact point by looking underneath holder 10. It will be recognized that the notch 50 between grip members 32 will preferably be the easiest point to insert and hold a utensil.

Utensil holder 10 may be used to hold items other than kitchen utensils. Screwdrivers, small hammers, and other devices may be inserted between grip members 32 and gripped by the elastomeric grip pair 30.

Thus it is seen that the objects of the invention are efficiently obtained. Although changes and modifications to the invention should be readily apparent to those having ordinary skill in the art, such changes would not depart from the spirit and scope of the invention as claimed.

I claim:

1. A device holder comprising:
an outer shell having a top wall, a front wall, a back wall, at least one open end, and an open bottom, wherein said outer shell defines a shell space;
at least one end cap configured to fit into said at least one open end; and,
a plurality of grip pairs, each of said grip pairs including two grip members, wherein each of said plurality of grip pairs contacts each adjacent grip pair;
wherein all of said plurality of grip pairs is housed within said shell.

2. The device holder as recited in claim 1 wherein said at least one open end is a pair of opposing open ends and said at least one end cap is a pair of end caps wherein each of said pair of end caps is configured to fit into one of said pair of opposing open ends.

3. The device holder as recited in claim 1 wherein all of said plurality of grip pairs is housed completely within said shell space.

4. The device holder as recited in claim 1 wherein all of said plurality of grip pairs is housed partially within said shell space.

5. The device holder as recited in claim 1 further comprising a pair of opposing brackets, wherein one of said pair of opposing brackets is attached to each of said front wall and said back wall.

6. The device holder as recited in claim 1 further comprising a pair of bosses offset from opposing edges of each of said pair of end caps, wherein said each of said pairs of bosses form friction fit with an inner surface of each of said front wall and said back wall.

7. The device holder as recited in claim 1 wherein each of said pair of end caps further comprises a header offset from a top edge of each said end caps and configured to fit under said top wall.

8. The device holder as recited in claim 7 wherein each header includes an attachment orifice.

9. The device holder as recited in claim 1 wherein one of said two members of each of said grip pairs contacts the other of said two members of each of said grip pairs.

10. The device holder as recited in claim 1 wherein each grip member is c-shaped and includes a plurality of contact ridges on an outer surface of the curve of said c-shaped grip member.

11. The device holder as recited in claim 10 wherein said ridges of one grip member of each grip pair contact said contact ridges of said other grip member and said ridges of each grip member of said each grip pair extend toward said top wall.

12. The device holder as recited in claim 10 wherein said ridges of one grip member of each grip pair contact said contact ridges of said other grip member and said ridges of each grip member of said each grip pair extend away from said top wall.

13. The device holder as recited in claim 10 wherein each of said grip pairs forms an upper notch and a lower notch when said contact ridges on each of said grip members of each of said grip pairs are in contact.

14. The device holder as recited in claim 13 wherein each of said upper notches and said lower notches on each one of said plurality of grip pairs is aligned to form an upper continuous groove and a lower continuous groove.
